(19) United States
(12) Patent Application Publication
(10) Pub. No.: US 2014/0164094 A1
(43) Pub. Date: Jun. 12, 2014

(54) PRECISE TARGETED PROMOTIONAL OFFERS

(71) Applicant: YAHOO! INC., Sunnyvale, CA (US)

(72) Inventor: Tarun Bhatia, Oak Park, CA (US)

(73) Assignee: YAHOO! INC., Sunnyvale, CA (US)

(21) Appl. No.: 13/707,129

(22) Filed: Dec. 6, 2012

(51) Int. Cl. G06Q 30/02

(52) U.S. Cl. CPC G06Q 30/0251
USPC 705/14.41; 705/14.49; 705/14.61; 705/14.58; 705/14.56

(57) ABSTRACT

Techniques for facilitating targeted discounts are described. A request to distribute a promotional offer is received from a merchant. The promotional offer may be at least partially preconfigured, is maintained at the deal service, and may indicate an item (e.g., a product and/or service) offered by the merchant. The promotional offer is distributed immediately after the request is received. The user set to receive the promotional offer is determined. The promotional offer is provided to at least one user in the user set. The promotional offer is confirmed with the users that accepted the promotional offer.

### BACKGROUND OF THE INVENTION

1. Field of the Invention

The present invention relates to online deals and incentives.

2. Background

For many years, customers have been able to shop for products and services. Traditionally, a customer has been able to purchase a product or service from a merchant. The merchant may occasionally offer discounts on their products and/or services. Such discounts may benefit customers with lower prices, and may benefit merchants with an increase in sales volumes, enabling excess inventory to be reduced among other benefits. In some cases, a merchant may offer a group discount to a group of customers desiring a particular product or service. Examples of such group discounts include vacation package deals, and tickets to museums for families or groups of ten or more persons.

In recent years, the Internet has provided a new medium for customers to purchase products and services from merchants. For example, thousands of electronic commerce websites such as amazon.com provided by Amazon.com, Inc. of Seattle, Wash., and ebay.com, provided by eBay Inc. of San Jose, Calif., have been established that sell products and services over the Internet. The availability of products and services for sale on the Internet has made shopping more convenient for customers and has enabled merchants to reach larger numbers of customers.

Some websites have recently been providing coupons for discounted products and services to groups of users over the Internet. Examples of such websites include groupon.com, provided by Groupon, Inc. of Chicago, Ill. and livingsocial.com provided by LivingSocial of Washington, D.C. According to such deal websites, merchants provide coupons to the websites to be presented to a large pool of users that subscribe to emails of the website. The emails are typically delivered on a regular schedule, such as once per day at a same time each day, and include the coupons provided by the merchants. A coupon in an email may be activated if a predetermined minimum number of persons that receive the email sign up for the coupon. For instance, a discounted price for a product or service may be offered to users, and if a predetermined number of users sign up for the offer, then the deal becomes available to the users.

### BRIEF SUMMARY OF THE INVENTION

Various approaches are described herein for, among other things, providing targeted discounts to users. In a targeted discount, a targeted promotional offer is configured based on information received from merchants. A fully complete or configurable promotional offer may be maintained for a merchant. The merchant may transmit a request that the maintained promotional offer be offered to one or more consumers in an immediate time period. The merchant may provide information in the request to fully configure the maintained promotional offer (if the maintained promotional offer is not complete). The promotional offer is offered to a selected set of consumers. The selected set of consumers may include one or more passerby users and/or one or more repeat users. The promotional offer is open to being accepted by the set of consumers during the immediate time period, after which the promotional offer expires.

For instance, in a method implementation, a request to distribute a promotional offer is received from a merchant. The promotional offer is maintained at the deal service, may be at least partially preconfigured, and indicates an item offered by the merchant. The promotional offer is distributed immediately after the request is received. A user set to receive the promotional offer is selected. The promotional offer is provided to at least one user in the user set. The promotional offer is confirmed with the users that accepted the promotional offer.

The confirmations of the promotional offer are tracked and analyzed. The tracked confirmations are analyzed to identify trends of successful promotional offers, and to identify characteristics of the user that accepted the promotional offers.

In another method implementation, a request to distribute a promotional offer is received from a merchant. The promotional offer is maintained at the deal service and may be at least partially preconfigured. A user set to receive the promotional offer is selected that includes at least one passerby user and at least one repeat user. The promotional offer is configured to offer a first discount to a passerby user and to offer a second discount to a repeat user. The promotional offer is provided to at least one user in the user set. The promotional offer is confirmed with the users that accepted the promotional offer. The offer of the promotional offer may be stopped according to criteria received in the request.

A user may be selected to be a passerby user or a repeat user by determining whether the user's current geographical location is within a geographical area associated with the merchant, whether the user has previously been a customer of the merchant, and whether a stored consumer location (e.g., a home address of the user) is within the geographical area associated with the merchant.

Discounts provided in the offer may be constant or tiered. For instance, in one tiered discount implementation, the promotional offer may be offered to a passerby user at a first tiered discount during a first time period, offered to the passerby user at a second tiered discount during a second time period, offered to a repeat user at a third tiered discount during the first time period, and offered to a repeat user at a fourth tiered discount during the second time period.

In a system implementation, a targeted discounting system includes a merchant offer interface that receives a request to distribute a promotional offer from a merchant. The promotional offer is maintained at the database and is distributed immediately after the request is received. The promotional offer indicates an item offered by the merchant. The targeted discounting system includes a database that stores merchant information, consumer information, and offer information. The targeted discounting system includes a consumer interface that provides promotional offers to a consumer and receives acceptance of the promotional offers from the consumer. The targeted discounting system includes a deal matcher module that accesses the promotional offer in the database, selects at least one consumer, provides the promotional offer to the consumer, and confirms the promotional offer with the consumer that accepted the promotional offer.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 shows a block diagram of a communication system for offering targeted discounts, according to an example embodiment.

FIG. 2 shows a flowchart providing a process for offering targeted discounts, according to an example embodiment.

FIG. 3 shows a block diagram of a deal matcher coupled to a database, according to an example embodiment.

FIG. 4 shows a flowchart providing a process for tracking and analyzing deals, according to an example embodiment.

FIG. 5 shows a flowchart providing a process for analyzing deals, according to an example embodiment.

FIG. 6 shows a flowchart providing a process for offering targeted discounts, according to an example embodiment.

FIG. 7 shows a block diagram of a user set determiner coupled to a database, according to an example embodiment.

FIG. 8 shows a flowchart providing a process for determining whether a user is a passerby user or a repeat user, according to an example embodiment.

FIG. 9 shows a process for determining whether a user is a passerby user or a repeat user, according to an example embodiment.

FIG. 10 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Numerous exemplary embodiments of the present invention are described as follows. It is noted that any section/subsection headings provided herein are not intended to be limiting. Embodiments are described throughout this document, and any type of embodiment may be included under any section/subsection.

Websites exist that provide coupons for discounted products and services, such as groupon.com and livingsocial.com. Some of these websites provide coupons that are activated or confirmed if a predetermined minimum number of persons sign up for a particular deal (e.g., a “Groupon®”). For instance, a provider may offer a discounted price for a product or service to users. The offer may be made to the users by email or other communication. If a predetermined number of users sign up for the offer, then the deal is confirmed and becomes available to all of the users.

However, such techniques for providing coupons have limitations because these techniques are based on a large number of users and a long-term time period. These techniques do not specifically consider the interest of small or very small merchants in the generation of the deals.

For instance, such websites that use wide distribution of coupons provide questionable value with deep discounts that do not necessarily translate into sustainable long term value for the vendors providing the coupons. Furthermore, small business owners can be more susceptible to variations in demand due to many factors (e.g., weather, traffic, etc.). Such vendors have no deal service available that they can access when needed—in an immediate short duration time period (e.g., for the next 5 minutes, the next 30 minutes, the next hour, the next two hours, etc.)—that is responsive in real time, precise in the discounts that are provided, and limited in down side exposure.

Furthermore, small business owners are frequently hard pressed for time just keeping operations running, and may have little or no time available to manage the effectiveness of complex marketing channels. Such vendors do not have access to a simple and responsive mechanism to reach potential new and existing customers who may instantly respond and receive items (e.g., products, services, etc.) that would otherwise go unused.

In embodiments, improved techniques are provided for targeted couponing where merchants are enabled to specify a maximum number of items that are available for an offer, and a time period in which the offer is available. Such embodiments enable merchants to request offers to be made immediately, to be offer for relatively short time durations, and may be offered to relatively smaller numbers of customers. Such smaller-scale deal offering may be referred to as “micro-couponing.” Such offers may be provided to customers relatively instantaneously, and direct feedback to such offers may be received quickly. Such offers may be made in a very precise manner, and their effectiveness is verifiable. As such, embodiments provide improvements over current promotional techniques, such that merchants are able to precisely specify the number of items available and a time period for a deal they want to offer.

Example embodiments for such deal/offer techniques are described in the following subsections. Although such deal and offer embodiments are frequently described as being applicable to relatively small size businesses, smaller quantities of offered items, and relatively short duration time periods, such embodiments are also applicable to other sized businesses (e.g., medium and large sized businesses), other quantities of offered items (e.g., medium and larger quantities of offered items), and other during time periods (e.g., medium and longer duration time periods). Furthermore, such deal and offer embodiments may be applicable to specific locations of a large chain of businesses, to specific styles, sizes or colors of a specific product item, etc.

### A. Example Group Discounting System Embodiments

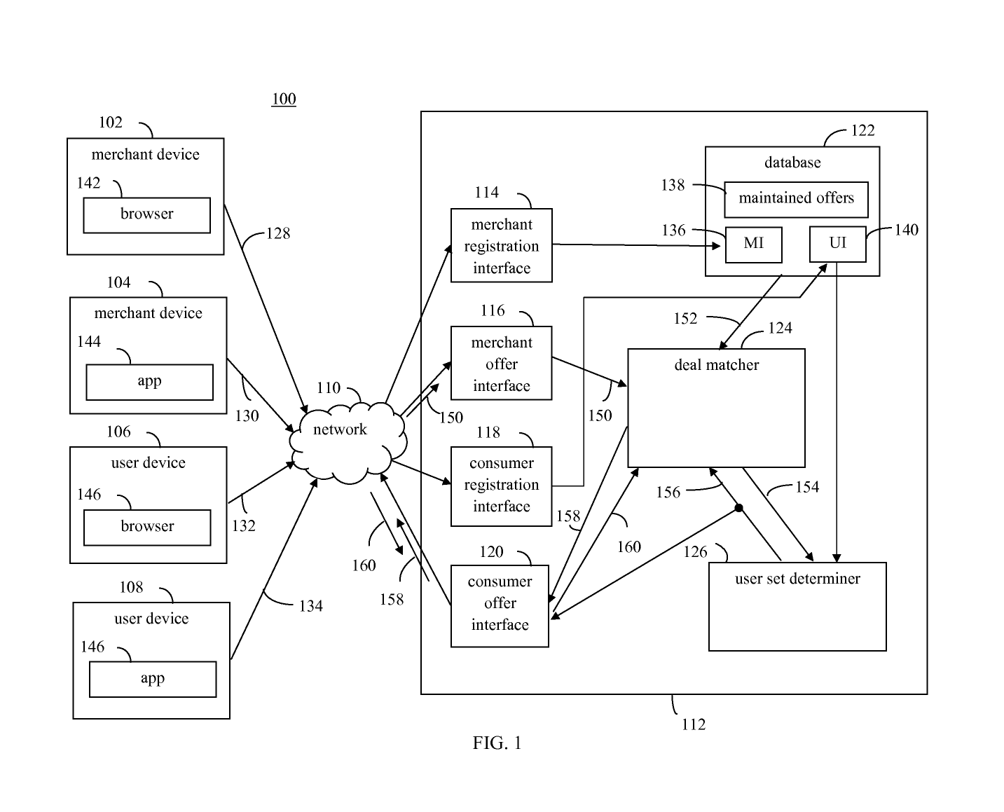

Embodiments may be implemented in a variety of environments. For instance, FIG. 1 shows a block diagram of a communication system 100 in which targeted discounts may be offered, according to an example embodiment. System 100 is shown for purposes of illustration, and embodiments may be implemented in other environments, as would be apparent to persons skilled in the relevant art(s) from the teachings herein. As shown in FIG. 1, system 100 includes merchant devices 102-104, user devices 106-108, a network 110, and a targeted discounting system 112. Furthermore, targeted discounting system 112 includes a merchant registration interface 114, a merchant offer interface 116, a consumer registration interface 118, a consumer offer interface 120, a database 122, a deal matcher 124, and a user set determiner 126. System 100 is described as follows.

Merchant devices 102-104 and user devices 106-108 may each be any type of stationary or mobile computing device, including a desktop computer (e.g., a personal computer, etc.), a mobile computer or computing device (e.g., a Palm® device, a RIM Blackberry® device, a personal digital assistant (PDA), a laptop computer, a notebook computer, a tablet computer (e.g., an Apple iPad™), a netbook, etc.), a smart phone (e.g., an Apple iPhone, a Google Android™ phone, a Microsoft Windows® phone, etc.), or other type of computing device.

Merchant registration interface 114 and merchant offer interface 116, consumer registration interface 118 and consumer offer interface 120, database 122, deal matcher 124, and user set determiner 126 make up targeted discounting system 112. Merchant registration interface 114 and merchant offer interface 116, consumer registration interface 118 and consumer offer interface 120, database 122, deal matcher 124, and user set determiner 126 may be implemented in one or more computer systems, including one or more servers, which may be any type of computing device described herein or otherwise known that is capable of enabling the corresponding functionality described herein.

Merchant devices 102-104 may communicate via network 110 with merchant registration interface 114 and merchant offer interface 116, and user devices 106-108 may communicate via network 110 with consumer registration interface 118 and consumer offer interface 120, using any suitable communication technique. Network 110 may be a LAN (local area network), a WAN (wide area network), or any combination of networks, such as the Internet. Merchant devices 102-104 are each coupled with network 110 through a corresponding one of communication links 128-130, and user devices 106-108 are each coupled with network 110 through a corresponding one of communication links 132-134. Communication links 128-130 and 132-134 may each include wired and/or wireless links. Examples of communication links 128-130 and 132-134 include IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB (universal serial bus) links, etc.

Note that although two merchant devices and two user devices are shown in FIG. 1 (corresponding to two merchants and two users), these numbers are shown for ease of illustration. In embodiments, any number of merchant devices and user devices may be present in system 100, including tens, hundreds, thousands, millions, and even greater numbers of merchant devices and/or user devices.

Targeted discounting system 112 assists merchants (entities that offer items—one or more products and/or services—such as businesses, sole proprietors, partnerships, corporations, etc.), in selling their items to consumers (e.g., customers, users, persons, etc.) by enabling the merchants to provide discounts and/or other deals to consumers for their items. For instance, merchant registration interface 114 is configured to receive registration information from merchants through merchant device 102-104 via network 110. Such registration information is shown in FIG. 1 as merchant information (MI) 136. Merchant information 136 may include registration information for any number of merchants. In this manner, merchants can use targeted discounting system 112 to provide deals to consumers. For instance, merchants may provide registration information such as a merchant name, one or more types of product or service that may be offered by the merchant, a location of the merchant, etc. As shown in FIG. 1, merchant registration interface 114 may store merchant information 136 in database 122, to be maintained by targeted discounting system 112.

Furthermore, a merchant may provide one or more partially preconfigured or fully preconfigured offers (i.e., at least partially preconfigured offers) to be maintained by targeted discounting system 112, which are referred to as maintained offers 138. Maintained offers 138 may subsequently be requested by the merchant to be offered to consumers. As shown in FIG. 1, merchant registration interface 114 may store maintained offers 138 in database 122, to be maintained by targeted discounting system 112.

For instance, a preconfigured offer may be a one-time offer or a recurring offer. The preconfigured offer may include a start time and stop time, and may include a maximum amount or capacity of items to be offered. A partially preconfigured offer may include one or more fields that may be filled in by a merchant when the merchant requests the offer to be provided to consumers. For instance, the merchant may indicate the time period for which the offer is to be offered (after which it expires), an identification of the offered item(s), an identification of the number of the items that are available, an identification of the particular discount, and/or further offer-related information. One or more these fields may alternatively be pre-filled (pre-configured) in the partially pre-configured offer. Once a partially preconfigured offer is filled in by targeted discounting system 112 (as described elsewhere herein), the partially preconfigured offer is subsequently offered to users by targeted discounting system 112, as described herein.

A fully preconfigured offer has no fields to be filled in at the time the merchant requests the offer to be offered. Instead, all offer information is already present in the fully preconfigured offer (e.g., time period of offer, identification of item(s) offered, number of items offered, the particular discount, etc.). The merchant may merely request that the fully preconfigured offer be offered, and the fully preconfigured offer is subsequently offered to users by targeted discounting system 112, as described herein.

For instance, in one example of a preconfigured offer (a fully preconfigured offer, or a partially preconfigured offer that has been filled in), a merchant associated with a restaurant may provide an offer of 20% off the entire restaurant bill for 3 patrons that is active for a time period of 5 pm until 7 pm tonight only. In another example, the merchant may provide an offer for 1 free drink at happy hour every Wednesday for up to 5 patrons. A preconfigured offer may be a one-time offer or may recur on a repeating schedule, such as daily or weekly or on another repeating schedule. A preconfigured offer may be offered to passerby customers only (persons that are either in, or likely to be in a position to redeem the offer during the indicated time period), to repeat customers, to a combination of passerby and repeat customers, and/or to other consumers. A preconfigured offer may offer different discount amounts to different consumer types. For example, a preconfigured offer may provide greater discounts to passerby customers and lesser discounts to repeat customers, or vice versa. A preconfigured offer may be increased or decreased at a predetermined rate. For example, a preconfigured offer may provide an initial discount and, after a predetermined time period or number of confirmed acceptances, may provide a greater discount, increasing the discount until the maximum number of users has accepted. Alternatively, a preconfigured offer may provide an initial discount and, after a predetermined time period or number of confirmed acceptances, may provide a lesser discount, decreasing the discount until the maximum number of users has accepted. In an example, the merchant may provide an offer for 10% off the entire restaurant bill for 5 patrons for a time period of the next four hours. After one hour, if the offer is not completed, the merchant may increase the offer to 20% off the entire restaurant bill, and, after two hours, if the offer is not completed, increase the offer to 30% off the entire restaurant bill, etc.

Consumer registration interface 118 is configured to receive registration information from users at user devices 106-108 via network 110. Such registration information is shown in FIG. 1 as user information (UI) 140 (also referred to as “consumer information”). User information 140 may include registration information for any number of users. By reference to user information 140, the users can be targeted by registered merchants to receive deals. For instance, user may provide registration information such as a user name, demographic information (e.g., gender, age, etc.), a home location, a work location, and other locations that the user may frequent (e.g., daycare location, etc.), item preferences (e.g., technology products, favorite foods, hobbies, etc.) and/or further information and/or preferences. As shown in FIG. 1, consumer registration interface 118 may store user information 140 in database 122, to be maintained by targeted discounting system 112.

Merchant registration interface 114 and consumer registration interface 118 may be configured to enable merchants and users to provide registration information in any manner. For instance, in an embodiment, merchant registration interface 114 and/or consumer registration interface 118 may generate a web page or other user interface (e.g., a graphical user interface) that includes a Tillable form that may be displayed to a merchant or user by a web browser shown as a web browser 142 (at merchant device 102) and a web browser 146 (at user device 106), or may be shown in a user interface displayed by an application (e.g., by an application executing in a desktop computer, a web application hosted in a browser, a mobile “app” at a mobile device, etc.) shown as an app 144 (at merchant device 104) and an app 148 (at user device 108). In other embodiments, merchant registration interface 114 and/or consumer registration interface 118 may receive registration information in an email message, in a text message, in a social network message, or in another manner from a merchant device or user device. In still other embodiments, merchant registration interface 114 and/or consumer registration interface 118 may receive registration information in other ways. Browser 142 and application 144 enable maintained offers 138 to be configured, adjusted, and/or displayed to the merchants, and enable merchant information 136 to be provided. Browser 146 and application 148 enable user information 140 to be provided.

According to embodiments, deal matcher 124 enables merchants to request that their maintained offers be offered to users in real time, so that as soon as such a request is received from a merchant, a user set is determined to receive the indicated offer from the merchant, the offer may be filled in (if a partially preconfigured offer), and the offer may be transmitted to the user set. Users of the user set that accept the offer within the indicated time period, and within the allotted maximum number of users that may accept, may have the offer confirmed with them by deal matcher 124, and may thereby partake in the offer.

For instance, as shown in FIG. 1, deal matcher 124 receives targeted promotional offer request 150. Targeted promotional offer request 150 indicates a maintained offer of maintained offers 138 that is requested by the merchant to be offered to users, and may optionally include information to be used to complete the maintained offer. In response to request 150, deal matcher 124 retrieves the maintained offer identified in request 150 from maintained offers 138 (in database 122) as requested offer 152. Deal matcher 124 may fill in requested offer 152 (if requested offer 152 is partially preconfigured) with information included in request 150. For instance, deal matcher 124 may fill in an identification of one or more items associated with the deal, one or more associated discounts, a time period of the offer (e.g., a start time if not immediate, and a stop or end time), a maximum number of each item that is available, etc. Furthermore, deal matcher 124 may interact with user set determiner 126 to determine the users to which requested offer 152 is to be delivered.

For instance, deal matcher 124 may provide information relating to request 150 to user set determiner 126 in a user set request 154, such as an identification of a maximum number of users to which the offer may be made, an identification of the offered item(s), etc. In response, user set determiner 126 accesses database 122 for user information 140, and determines a set of users to be provided with the indicated offer. For example, user set determiner 126 may select only passerby customers or repeat customers, or may select a mixture of passerby customers and repeat customers. As described above, database 122 may store location-specific information for users registered in the system, including home location, work location, commute routes (e.g., between work and home, home and daycare, work and daycare, etc.), which may be entered by the user and/or calculated by a routing/mapping tool, etc. Database 122 may store information relating to repeat customer's merchant preferences, and may keep information received from merchants related to specific customers. Such information and/or other information may be used to determine the user set. When the user set is determined, user set determiner 126 provides the determined user set to deal matcher 124 as determined user set 156.

Deal matcher 124 uses determined user set 156 as the set of users to be provided with requested offer 152. Accordingly, deal matcher 124 transmits requested offer 152, which may optionally have one or more fields filled in by deal matcher 124 (if partially preconfigured), to the users of user set 156 via consumer offer interface 120 as configured targeted promotional offer 158. For instance, consumer offer interface 120 may receive user set 156 from deal matcher 124, and transmit configured targeted promotional offer 158 to each user of user set 156. For example, configured targeted promotional offer 158 may be presented to a first user at user device 106 and a second user at user device 108 (as well as additional users at corresponding user devices not shown in FIG. 1) through network 110. Consumer offer interface 120 may transmit configured targeted promotional offer 158 to the users of user set 156 in any manner, including as a message that may appear in an application at a user device (e.g., a mobile app, a desktop application, etc.) such as a text message, an email message, an instant message, a social network message, etc.

The first user at user device 106, the second user at user device 108, and/or other users included in user set 156 may receive configured targeted promotional offer 158, and may accept configured targeted promotional offer 158 if desired. For instance, to accept configured targeted promotional offer 158, a user may agree to purchase an item included in offer 158 at a discount. As shown in FIG. 1, a user device of an accepting user, such as user device 106 of the first user, may transmit an offer acceptance 160, which is received at consumer offer interface 120, and is provided to deal matcher 124. Any number of offer acceptances 160 may be received from user devices, depending on a number of users to which offer 158 was delivered to and was accepted by. In an embodiment, deal matcher 124 may transmit an acceptance confirmation to all users that accepted the offer (up to the maximum number of items that are offered), to indicate that those users can use the item.

In one embodiment, configured targeted promotional offer 158 may be transmitted to all users in user set 156, and the offer is confirmed with a first number of the users that accept the offer that is less than or equal to a maximum number of users/items that the offer is configured for.

In another embodiment, promotional offer 158 is offered serially to the users of user set 156, one user at a time. When promotional offer 158 is accepted or rejected by a user, promotional offer 158 is then offered to another user in the user set, until the maximum number of available offers is reached. Alternatively, promotional offer 158 may be offered to a group of users of user set 156, such as to 2 or 4 users at a time, or another size group of users, until the maximum number of available offers is reached. In this way, a merchant can precisely target customers and maintain control over the number of discounts provided at any specific time.

In an embodiment, the time period indicated for configured targeted promotional offer 158 is a time period occurring immediately after or soon after request 150 is transmitted by the merchant device of the merchant and received by targeted discounting system 112. In an embodiment, the offer may be provided to users “immediately” after the request is received, meaning that the offer is delivered to users as soon as request 150 is processed by targeted discounting system 112, with such processing including any processing time internal to targeted discounting system 112 needed to process request 150, and with no additional intentional delays being present (e.g., offer 158 is not intentionally held for a particular delivery time/date, etc.). In other words, the item(s) of offer 158 may be offered immediately after request 150 is received and processed by targeted discounting system 112 for delivery when ready without any additional intentional built-in delays. By delivering offer 158 immediately, offer 158 may be delivered in less than a second, within seconds, or within other nearly instantaneous amount of time after request 150 is received by system 112. However, in another embodiment, request 150 may indicate a particular time at which offer 158 is to be transmitted to users (in a non-immediate fashion), or offer 158 may be processed in another manner that results in non-immediate delivery.

As such, in embodiments, the time period during which an offer is open may begin immediately (e.g., immediately after a time that request 122 is received from the merchant) or soon after (e.g., in a few minutes, in an hour, or in a few hours, etc.) after request 150 is received. In this manner, merchants may be enabled to have offers provided to users more rapidly than in conventional systems, which may be as soon as the merchant determines that the merchant has one or more items that the merchant desires to be sold. In contrast, conventional systems typically offer deals at regular times each day, and so are not capable of providing offers for merchants immediately in response to merchant requests. A “Groupon®” is an example of a deal offered by a conventional deal system that is not offered immediately after a request is received from a merchant, but rather is offered at a future predetermined time, which may be days or weeks after the merchant submitted the deal to the deal system.

Furthermore, the time period during which offer 158 may have any duration. For instance, in an embodiment, the time period may be a short time duration, such as a minute-termed or micro-duration (measured in terms of minutes; less than an hour), or an hour-termed duration (measured in terms of a number of hours that is substantially less than the length of day; less than several hours). In such an embodiment, merchants may be enabled to sell items that are available in a very short term period. In other embodiments, offer 158 may have longer durations.

Still further, user set 156 that offer 158 is directed to may include any number of users. For instance, in an embodiment, user set 156 may be a small number of users, such as a micro-set of users (e.g., 10 or fewer users), or an intermediate-sized set of users (e.g., 10-100 users). In such an embodiment, merchants may be enabled to unload very small item inventories, which may be particularly useful for small businesses. Alternatively, user set 156 may include larger numbers of users.

As such, in embodiments, offer 158 may be configured in various ways. For instance, offer 158 may be offered for a short-term time period, such as one or two hours, or for one afternoon or one evening, etc. Offer 158 may be a one-time offer or a recurring offer. Offer 158 may include a start time and stop time, and may include a maximum amount or capacity. For example, a preconfigured offer for a restaurant may be 20% off the entire bill for 3 patrons from 5 pm until 7 pm tonight only, or may be for 1 free drink at happy hour every Wednesday for up to 5 patrons. Similarly, a preconfigured offer for a boutique may include a maximum of 30% off one specific item on up to 8 of the specific item, or may be 10% off any purchase in the next 3 hours for up to 5 patrons.

Example embodiments for system 100 and further example embodiments for offering discounts to users are described as follows.

### B. Embodiments for Offering Targeted Discounts

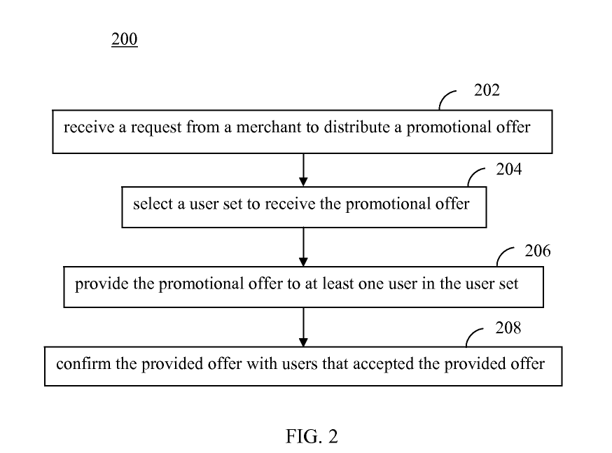

In embodiments, targeted discounting system 112 of communication system 100 may operate in various ways to facilitate targeted discounts. For instance, FIG. 2 shows a flowchart 200 providing a process for offering targeted discounts, according to an example embodiment. Flowchart 200 is described with respect to targeted discounting system 112 of communication system 100 for illustrative purposes. Further structural and operational embodiments will be apparent to persons skilled in the relevant art(s) based on the following description of flowchart 200 and targeted discounting system 112.

Flowchart 200 begins with step 202. In step 202, a request to distribute a promotional offer is received from a merchant. For example, in an embodiment, request 150 is received from a merchant, such as a merchant using first merchant device 102 (e.g., by interacting with browser 142) communicating over network 110 with merchant offer interface 116. Request 150 indicates an at least partially preconfigured offer of the merchant maintained by database 122 in maintained offers 138, such as requested offer 152. The merchant may have previously preconfigured requested offer 152, which may be a fully preconfigured offer, or a partially preconfigured offer.

In an embodiment, deal matcher 124 may generate configured targeted promotional offer 158 to be requested offer 152 as-is (when requested offer 152 is fully preconfigured), or may fill in one or more fields of requested offer 152 with data included in request 150 (when requested offer 152 is partially preconfigured) to generate configured targeted promotional offer 158. Configured targeted promotional offer 158 indicates at least one item offered by the merchant during a time period immediately after the request is received. Configured targeted promotional offer 158 expires after the time period.

For example, in one illustrative embodiment, a restaurant owner may want to fill three tables at his/her restaurant (e.g., “Joe's restaurant”). The restaurant owner may transmit a request 138 to targeted discounting system 112 that indicates an availability of three of the restaurant's items (service at 3 tables).

Referring back to flowchart 200 in FIG. 2, in step 204, a user set is selected to receive the promotional offer. In an embodiment, user set determiner 126 of FIG. 1 may select one or more users to be included in user set 156 using user information 140 regarding registered customers received from database 122. While request 150 may specify a particular number of items (e.g., 10 items for 10 consumers) are to be offered, user set 156 may be larger than the specified number of items. For example, when 10 items are to be offered, user set 156 may include 100 users, 1000 users, etc. This provides extra users in the event that some users do not accept the offer.

In an embodiment, users to be included in user set 156 may be selected in various ways. For instance, one or more of maintained offers 138 stored in database 122 may include selection criteria for users that the associated merchant has provided. This criteria for users may be used by user set determiner 126 to select users to be offered the corresponding offer. For instance, user set determiner 126 may use the user selection criteria associated with requested offer 152 when selecting users to be included in user set 156 for requested offer 152. Such user selection criteria may include preferred demographic information (e.g., gender, age range, etc.), location information, hobbies, historical information (e.g., prior purchase history, etc.), whether a user is a passerby user or a repeat user (as described in further detail below), and/or further types of user selection criteria. User set determiner 126 may compare the user selection criteria to characteristics of candidate users (e.g., as included in user information 14) to select those users that sufficiently match the user selection criteria to be included in user set 156 for requested offer 152. In other embodiments, additional and/or further techniques may be used by user set determiner 126 to select users for user set 156.

Continuing the illustrative restaurant example, user set determiner 126 may select ten users to be included in user set 156, in an attempt to fill the 3 available tables of the restaurant indicated in request 150.

In step 206 of FIG. 2, the promotional offer is provided to at least one user in the user set. The targeted promotional offer is offered to at least one user in user set 156. For instance, as shown in FIG. 1, deal matcher 124 generates offer 158, which is transmitted by consumer offer interface 120 through network 110 to user devices 106 and 108, as well as further user devices not shown in FIG. 1. Offer 158 may be offered to one user at a time (serially), or to multiple users at a time (e.g., to two users at a time, to three users at a time, to all of the users at the same time, etc.)

Continuing the illustrative restaurant example, deal matcher 124 retrieves requested offer 152 from maintained offers 138 in database 122, as was identified in request 150. Deal matcher 124 receives user set 156, which includes ten users selected by user set determiner 126. Deal matcher 124 may optionally fill in one or more fields of requested offer 152 (when present), if request 150 includes information to fill fields. For instance, requested offer 152 may include the following template text with two fields (shown as blanks) to be filled in:
This discount of ______ off of a meal at Joe's Restaurant is only good if presented before ______ today.

Furthermore, request 150 may include a discount amount (e.g., 20% off of a meal) that may be filled into a discount field of requested offer 152. Furthermore, the offer may be intended to begin immediately (e.g., 2 pm) and request 150 may include an end time for the offer (e.g., 4 pm), which may be filled into an end time field of requested offer 152. As such, offer 158 may be generated by deal matcher 124 to include the following text or similar message: “This discount of 20% off of a meal at Joe's Restaurant is only good if presented before 4 pm today.” This message may be transmitted in offer 158 to the ten selected users (e.g., in a text message, in an email, etc.).

In step 208 of FIG. 2, the users that have accepted the provided offer are confirmed. Each user at a user device may accept and confirm the promotional offer, if desired. As shown in FIG. 1, a user device of an accepting user, such as user device 106 of the first user, may transmit an offer acceptance 160, which is received at consumer offer interface 120, and is provided to deal matcher 124. Any number of offer acceptances 160 may be received from user devices, depending on a number of users to which offer 158 was delivered to and was accepted by.

Continuing the illustrative restaurant example, up to three of the users of user set 156 may accept offer 158, and provide corresponding offer acceptances 160. In this manner, the restaurant may have one or more of the three tables filled nearly immediately (e.g., as soon as one or more users receive and accept the offer, and are able to travel over to the restaurant). Furthermore, as shown in this example, relatively small numbers of items may be offered to relatively small numbers of consumers to enable a merchant to unload relatively small amounts of inventory/capacity that may otherwise go unsold/unused.

### C. Embodiments for Tracking and Analyzing Deals

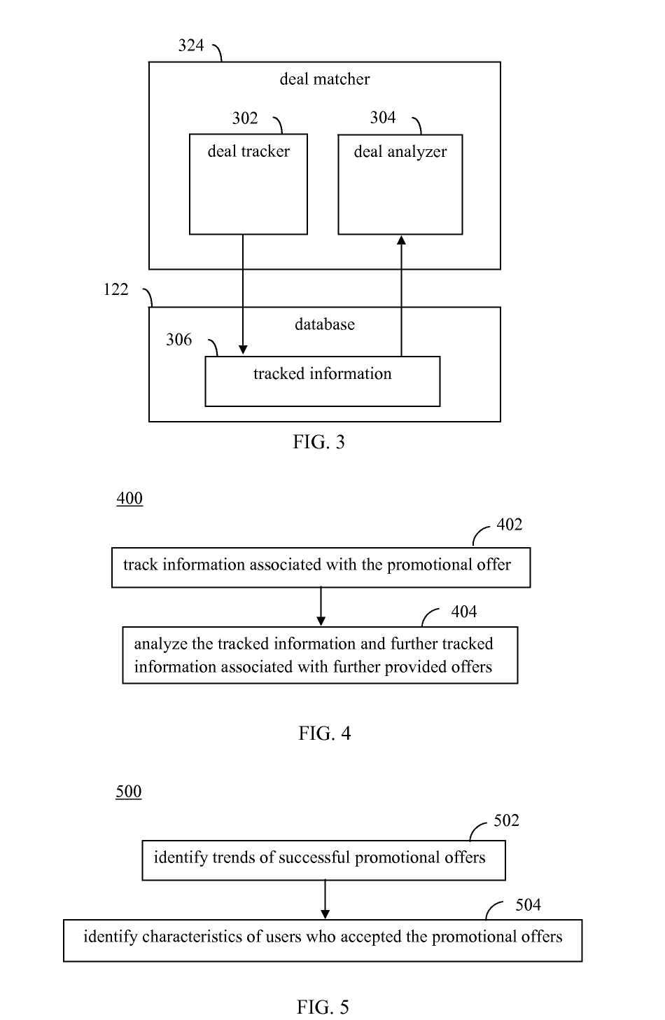

In an embodiment, after a promotional offer has been offered, accepted, and confirmed with users, the offer may be tracked and analyzed. For instance, FIG. 3 shows a block diagram of a deal matcher 324 coupled to a database 122, according to an example embodiment. Furthermore, FIG. 4 shows a flowchart 400 providing a process for tracking and analyzing discounts, according to an example embodiment. Flowchart 400 is described with respect to deal matcher 324 of FIG. 3 for illustrative purposes. As shown in FIG. 3, deal matcher 324 includes a deal tracker 302 and a deal analyzer 304. Deal tracker 302 communicates with database 122 to store and retrieve information. Flowchart 400 and deal matcher 324 are described as follows.

In step 402 of FIG. 4, information associated with a promotional offer is tracked. In an embodiment, deal tracker 302 tracks confirmations and other information of the promotional offer. Deal tracker 302 may store and track all relevant information for each promotional offer, including merchant identifier, a type of product or service offered, a type and/or amount of discount offered, a determined user set, identifiers for users who were offered and did not accept the offer, a list of identifiers for confirmed users, and/or further information regarding the offer. The information is stored in database 122 by deal tracker as tracked information 306.

In step 404 of FIG. 4, the tracked information and further tracked information associated with further provided offers is analyzed. In an embodiment, deal analyzer 304 analyzes the tracked confirmations and other information of the promotional offer. For instance, as shown in FIG. 3, deal analyzer 304 may retrieve tracked information 306 from database 122. Tracked information 306 may include tracked information for the present offer as well and further tracked information associated with further provided offers (e.g., previously offered). Deal analyzer 304 may analyze various aspects of tracked information 306, some examples of which are described further below. The analysis performed by deal analyzer 304 may be used in suggesting successful promotional offers to merchants. The analysis may be presented to the merchants to discover what other merchants in similar or different categories of products or services are offering, how they are configuring their offers, and/or to provide further beneficial information.

FIG. 5 shows a flowchart 500 providing a process for analyzing deals, according to an example embodiment. Analyzing deals may include identifying successful promotional offers, determining characteristics of the successful promotional offers, and determining which selected users accepted the successful promotional offers. When analyzing large amounts of data relating to successful promotional offers, useful information regarding successful discounts, successful user sets, and other information may be obtained. In an embodiment, flowchart 500 may be performed by deal analyzer 304 to analyze tracked information 306 (e.g., in step 404 of FIG. 4). Flowchart 500 is described as follows with respect to deal analyzer 304 for purposes of illustration.

In step 502 of FIG. 5, trends of successful promotional offers are identified. In an embodiment, deal analyzer 304 analyzes tracked information 306 to identify trends of successful promotional offers. In communication with deal tracker 302, deal analyzer 304 may determine successful promotional offers, including offers that are confirmed by the maximum number of users, and offers that are confirmed by the first users offered the promotional offer. Other indications of a successful promotional offer may include only offering the first tier of a graduated or tiered promotional offer, and offers that are quickly confirmed. Trends of successful promotional offers that may be identified include discounts offered, graduated or tiered discounts, time of day of particular discounts, and other information related to successful promotional offers.

In step 504 of FIG. 5, characteristics of users who accepted the promotional offers are identified. In an embodiment, deal analyzer 304 identifies characteristics of users who accepted and confirmed each promotional offer. These characteristics may include preferences of each user indicated at registration, previous offers accepted, geographical location, etc. This information generated by deal analyzer 304 can be used to configure future promotional offers, user sets, and to provide information to merchants reflecting successful promotional offers and target customers.

### D. Embodiments for Offering Discounts to Passerby and Repeat Consumers

In embodiments, targeted discounting system 112 of communication system 100 in FIG. 1 may operate in various ways to facilitate promotional offers targeted to passerby or repeat consumers. To a particular merchant, a “passerby” consumer is a consumer that resides at a geographical location that is remote or external to a geographical area in which the merchant performs business (e.g., within a particular distance or radius of the location of business of the merchant, etc.). The geographical location of the consumer may be a home address and/or work address indicated in user profile or registration information of the consumer (e.g., UI 140 of FIG. 1). To a particular merchant, a “repeat” consumer is a consumer that has previously been a customer of the merchant. In an embodiment, a record of consumers that are previous customers (repeat consumers) may be maintained for each merchant registered with targeted discounting system 112. This information may be included in MI 136 in FIG. 1, or elsewhere. Alternatively, a record of each merchant that a consumer has previously been a customer of may be maintained for each consumer registered with targeted discounting system 112. This information may be included in UI 140 in FIG. 1, or elsewhere.

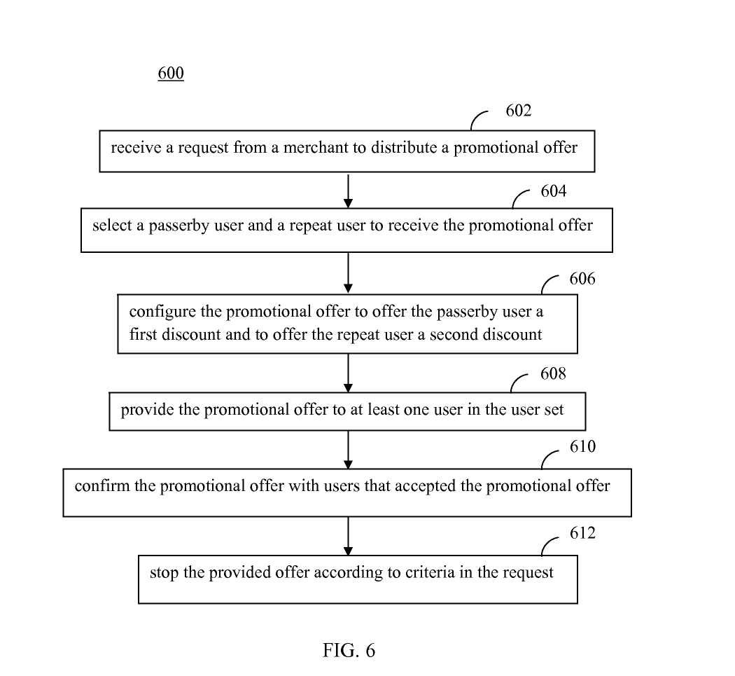

FIG. 6 shows a flowchart 600 providing a process for offering targeted discounts, according to an example embodiment. Flowchart 600 is described with respect to targeted discounting system 112 of communication system 100 of FIG. 1 for illustrative purposes. Further structural and operational embodiments will be apparent to persons skilled in the relevant art(s) based on the following description of flowchart 600 and targeted discounting system 112.

Flowchart 600 begins with step 602. In step 602, a request to distribute a promotional offer is received from a merchant. For example, in an embodiment, request 150 is received from a merchant, such as a merchant using first merchant device 102 (e.g., by interacting with browser 142) communicating over network 110 with merchant offer interface 116. Request 150 indicates an at least partially preconfigured offer of the merchant maintained by database 122 in maintained offers 138, such as requested offer 152. The merchant may have previously preconfigured requested offer 152, which may be a fully preconfigured offer, or a partially preconfigured offer. Request 150 may indicate one or more items to be filled in fields of requested offer 152, such as one or more discounts, and a maximum number of users that can accept the offer.

For instance, in an embodiment, requested offer 152 may be configured for a first number of passerby consumers and/or a second number of repeat consumers. For instance, requested offer 152 may specify a number of passerby customers only, repeat customers only, or a mixture of passerby and repeat customers. Accordingly, targeted discounting system 112 may distribute the offer to the specified number of passerby and/or repeat consumers. Furthermore, requested offer 152 may be configured to provide a same discount amount to passerby consumers and repeat consumers, or may be configured to provide different discount amounts to passerby consumers and repeat consumers.

For example, in one illustrative example, a preconfigured offer for a restaurant may be 40% off the entire bill for 3 passerby patrons and 10% off the entire bill for 2 repeat customers from 5 pm until 7 pm tonight only.

Referring back to flowchart 600 in FIG. 6, in step 604, a passerby user and a repeat user are selected to receive the promotional offer. As described above, user set determiner 126 is configured to select user set 156 to include one or more users to be delivered offer 158. In an embodiment, user set determiner 126 may be configured to generate user set 156 to include one or more passerby consumers and/or one or more repeat consumers. The desired number of passerby consumers and/or number of repeat consumers may be preconfigured in requested offer 152 by the merchant, or may have been received in request 150 from the merchant.

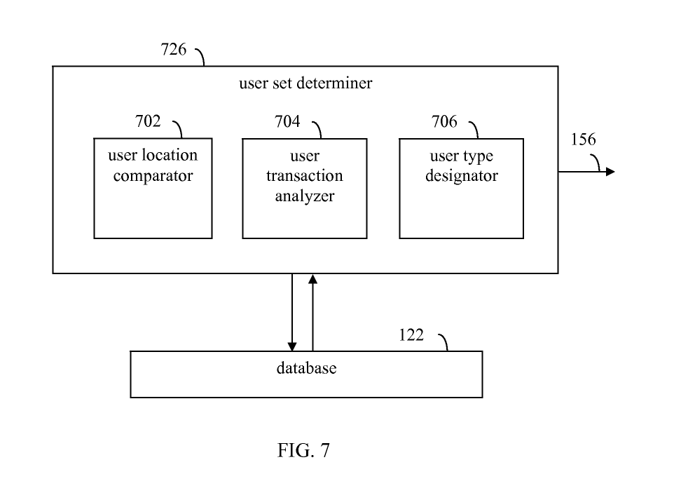

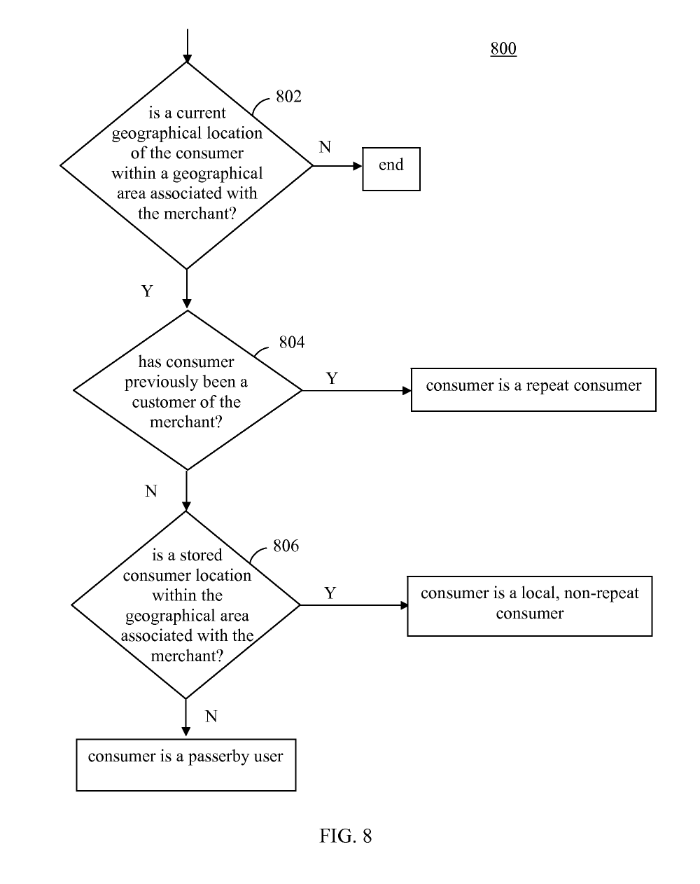

For instance, FIG. 7 shows a block diagram of a user set determiner 726 coupled to database 122, according to an example embodiment. User set determiner 726 is configured to generate user set 156 to include one or more passerby consumers and/or one or more repeat consumers. As shown in FIG. 7, user set determiner 726 includes user location comparator 702, user transaction analyzer 704, and user type designator 706. User set determiner 726 is described with respect to FIG. 8. FIG. 8 shows a flowchart 800 providing a process for determining whether a user is a passerby user or a repeat user, according to an example embodiment. Flowchart 800 and user set determiner 726 are described as follows.

In step 802 of flowchart 800, a current geographical location of the consumer is compared to a geographical area associated with the merchant. In an embodiment, for a particular consumer, user location comparator 702 compares a current location of the consumer with the geographical area associated with the business of the merchant (which may be included in MI 136 of FIG. 1). For instance, the current geographical location of the consumer may be determined by the user device of the consumer using location data from the mobile device interface (e.g., user device 106 in FIG. 1), such as by using GPS (global positioning system) techniques, by triangulation or trilateration (e.g., using cell towers), by the consumer inputting their current location into their user device, or in another manner. Current location may also include the current direction and speed of the user, and the most likely next destination of the user, which may be predicted from the user's calendar and appointments in the user device, or by other technique. If the current geographical location of the consumer is within the geographical area associated with the merchant, the consumer may be considered to receive the offer, and may be further analyzed to determine whether the consumer is a passerby or repeat consumer. In such case, operation proceeds to step 804. Otherwise, the consumer is not considered as eligible for the offer, and flowchart 800 ends for that consumer. A next consumer may then be analyzed according to flowchart 800.

Note that step 802 is optional, and flowchart 800 may be performed whether or not the consumer is currently located within the geographical area associated with the merchant (even if not, the consumer may still be provided with an offer).

In step 804, whether the consumer previously was a customer of the merchant is determined. In an embodiment, user transaction analyzer 704 analyzes stored information to determine whether the consumer has previously been a customer of the merchant. For example, as described above, MI 136 and/or UI 140 may indicate whether the consumer was previously a customer of the merchant. Operation proceeds to step 806 if the consumer is determined to not have been previously a customer of the merchant. If the consumer is determined to have been previously a customer of the merchant, the consumer is indicated as a repeat customer, and flowchart 800 ends for that consumer. A next consumer may then be analyzed according to flowchart 800, if desired (e.g., to fill out user set 156).

In step 806, a stored consumer location is compared to a geographical area associated with the merchant. In an embodiment, for the consumer, user location comparator 702 compares a stored home location of the consumer (which may be included in UI 140 of FIG. 1) with the geographical area associated with the business of the merchant. This comparison indicates whether the consumer may be considered a passerby consumer (by not residing in the geographical area of the merchant). If the stored consumer location is within the geographical area associated with the merchant, the consumer may not be considered a passerby consumer, and instead, the consumer is indicated as a local, non-repeat consumer and flowchart 800 ends for that consumer. The local, non-repeat consumer may be included in user set 156 if desired. If the stored consumer location is not within the geographical area associated with the merchant, the consumer may be considered a passerby consumer, and flowchart 800 ends for that consumer. A next consumer may then be analyzed according to flowchart 800, if desired (e.g., to fill out user set 156).

In an embodiment, user set determiner 726 may generate user set 156 to include the desired number of passerby consumers and/or repeat consumers, and optionally to include one or more local, non-repeat consumers if desired. While an offer may specify only a particular number of passerby and repeat consumers (e.g., 6 passerby patrons and 3 repeat patrons), user set 156 may include additional numbers of passerby and/or repeat consumers (in case some consumers decide not to accept the offer).

Referring back to FIG. 6, in step 606 of FIG. 6, the promotional offer is configured to offer the passerby user a first discount and to offer the repeat user a second discount. In one embodiment, offer 158 may be configured by deal matcher 124 to offer the same discount to passerby and repeat consumers. In another embodiment, offer 158 may be configured to offer passerby users a first discount and to offer repeat users a second discount. The first discount may be greater than the second discount, or may be less than the second discount. In this manner, a merchant may indicate a preference for passerby consumers to accept the offer over repeat consumers by giving passerby consumers a greater discount. For instance, the merchant may prefer to give new customers a better deal to entice them to return, and/or may be attempting to expand to a larger geographical range of customers by giving passerby consumers a better deal. Alternatively, the merchant may indicate a preference for repeat consumers to accept the offer over passerby consumers by giving repeat consumers a better discount. For instance, the merchant may desire to reward loyal customers over consumers that are merely passing by.

Additionally, the discounts included in offer 158 by deal matcher 124 may be graduated or tiered. For instance, offer 158 may be configured to offer consumers (e.g., passerby consumers, repeat consumers, all consumers, etc.) a first discount during a first time interval or other indicator (e.g., after a predetermined number of offer acceptances are received), a second discount during a second time interval or other indicator, etc. The first discount may be greater than the second discount, or may be less than the second discount, etc. In this manner, over time, the discount levels may be changed for an offer to make the offer more or less enticing, as desired.

Referring back to flowchart 600 in FIG. 6, in step 608, the promotional offer is provided to at least one user in the user set. As configured in step 606, offer 158 may be delivered to at least one passerby user and/or at least one repeat user included in user set 156, and as described elsewhere herein, such as with respect to step 206 of flowchart 200 (FIG. 2).

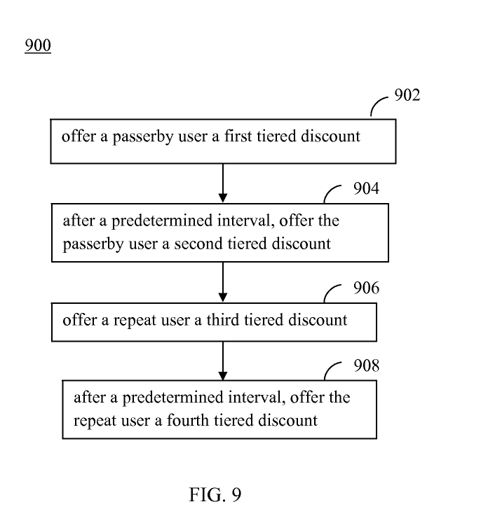

It is noted that in embodiments, the values or amounts of discounts offered to consumers in step 608 may change over time. For instance, FIG. 9 shows a flowchart 900 providing a process for providing tiered discounts of users, according to an example embodiment. In the example of flowchart 900, a passerby user and a repeat user are provided with tiered discounts that change over time, but in further embodiments, any combination of user types and numbers of users may be present that receive discounts with changing values. Flowchart 900 is described as follows.

In step 902 of FIG. 9, a passerby user is offered a first tiered discount. In an embodiment, deal matcher 124 may configure offer 158 to the passerby user (at the user device of the passerby user) with a first discount value for an item included therein. The first discount value may be included in offer 158, and delivered in a first message to the passerby user.

In step 904 of FIG. 9, after a predetermined time interval, the passerby user is offered a second tiered discount. In an embodiment, deal matcher 124 may change the value of the first discount value to a different, second discount value. The first tiered discount may be greater than the second discount, or may be less than the second tiered discount. The second discount value may be included in offer 124, and delivered in a second message to the passerby user.

In step 906 of FIG. 9, a repeat user is offered a third tiered discount. In an embodiment, deal matcher 124 may configure offer 158 to the repeat user (at the user device of the repeat user) with a third discount value for an item included therein. The third discount value may be greater than the first or second discount values, or may be less than the first or second discount values. The third discount value may be included in offer 158, and delivered in a first message to the repeat user.

In step 908 of FIG. 9, after a predetermined time interval, the repeat user is offered a fourth tiered discount. In an embodiment, deal matcher 124 may configure offer 158 to the repeat user (at the user device of the repeat user) with a fourth discount value for an item included therein. The fourth discount value may be greater than the third discount, or may be less than the third discount value. The fourth discount value may be included in offer 158, and delivered in a second message to the repeat user.

Referring back to FIG. 6, in step 610 of flowchart 600, the users that have accepted the promotional offer are confirmed. As described above, consumers, such as a passerby user and/or a repeat user may accept an offer by providing offer acceptance 160, which is received by deal matcher 124. As described above, deal matcher 124 may transmit an offer confirmation to accepting users to confirm their acceptance.

In step 612, the provided offer is stopped according to criteria in the request. In an embodiment, deal matcher 124 stops offering offer 158 to users in the user set (including stopping accepting acceptance of offers from further users) based on criteria included in request 150, such as when the total number of users have accepted and confirmed the offer, when the total number of items or services has been purchased, or when a specified time period has elapsed. Alternatively, deal matcher 124 may stop offering offer 158 based on criteria not included in request 150 (e.g., elapsing of a standard time period, etc.).

### E. Further Example Embodiments

Accordingly, embodiments are provided herein for targeted deals/offers that provide coupons, discounts, and/or other commercial incentives to entice consumers to purchase items from merchants. Such targeted offers may be scaled in any manner, including being “micro-coupons” for a small number of available items, a small user set, in an immediate time frame, as well as covering medium and large numbers of available items, medium and large user sets, and immediate and less immediate time frames. Examples of micro dimensions for refinement of an offer include: location (e.g., specific stores for a large chain), item (e.g., specific options, styles or colors or sizes only), time (e.g., signup now, redeem by 4 hours), targets (e.g., available to specific profile of users), and offers (e.g., specifically tuned as conditions vary over the non-configured set by the system automatically for maximal utility to the merchant, balancing risk and reward).

Thus, embodiments enable micro-couponing: most current mechanisms for provide offers at a larger scale, and thus need to be configured and scheduled in advance. Micro-couponing enables these constraints to be relaxed, and can be performed with precision. Embodiments enable precise control in terms of the number of offers that may be performed, and the fine slices of time during which such offers can be run (e.g., in terms of minutes). Embodiments enable direct and immediate feedback and lead generation: for instance, small businesses with perishable and transient capacity are enabled to “push a button” to request an offer to be delivered and have that capacity utilized with paying and profitable customers. Embodiments enable the system to leverage data collected from user and merchant activity to optimize offers on behalf of the merchant, including their specific goals for the offer.

Embodiments may use a precise push technique: small business owners, through an interface, can configure promotional offers that are broadcast to a user set for a limited number of sign ups, and that may be redeemed instantly. The limit on the number of users that may sign up may be enforced automatically, thereby limiting the exposure for the small business owner, while ensuring capacity utilization. Embodiments may use a consumer pull technique: consumers searching for related services may be enabled to sign up for offer alerts when offers are available as they move through an area with their smart phone devices (passerby users), or when they are already within the area on less mobile platforms (local and/or repeat users). Embodiments may enable marketplace matching: users that are more likely to respond may be sent offers, taking into account the location of the user and their speed, and the time expiration for redemption, enabling the users to sign up directly with a merchant or through the provided targeted discounting system. Embodiments may use learning: learning techniques may be employed to inform small business owners of the most efficient promotional mechanisms and their configuration, to provide improved utility for their profile. Embodiments may provide recommendations to merchants with little sophistication to preconfigure offers using desired goals and maximal exposure (e.g., to achieve stable demand in off-peak hours, clear excess inventory, etc.).

Embodiments may include one or more of the following elements:

Consumer interface: a consumer interface, such as an application interface layer, may complement search queries with clearly indicated micro-couponing offers, and may provide the ability to sign up for the promotion for a specific business.

Merchant interface: a merchant may configure a profile that may include one or more preconfigured offers. The merchant may subsequently have a preconfigured offer deployed with a trigger (e.g., a request from the merchant), and may provide a budget, resulting in the broadcast and subscription by a limited number of short lived offers. Passerby users (e.g., on a smart phone), existing registered loyal customers, and further types of consumers may be targeted with offers.

Specific promotions per targeted segment: various levels of discounts may be provided to different types of consumers, such as providing deeper discounts to full capacity for new passerby customers that are not likely to expect deeper prices going forward and shallower discounts for existing customers to lure them in the moment.

Services: a services layer may enable querying from user devices (e.g., a smart phone) and other applications with details on nearby promotions, which a consumer can sign up for and avail in the moment.

Marketplace Matching Algorithms: algorithms may respond with ranked and scored recommended promotions, to enable querying users with real intent to sign up for promotions for nearby services at small business owners.

In embodiments, consumers can search for nearby stores or service providers and receive a list that includes promotional offers including how many promotional offers are available or remaining. When a customer selects a promotional offer, the promotional offer may be offered to the customer, or the promotional offer may be completed and unavailable. A customer may request any available deal and receive a random or targeted selection of available promotional offers.

Note that the above illustrative examples are provided for purposes of illustration and are not intended to be limiting. Embodiments may be implemented with any number and different types of items, for any numbers of consumers, during any particular time frame, and by any size of merchant (sole proprietor, small business, medium sized business, large sized business, etc.) as would be apparent to persons skilled in the relevant art(s) from the teachings herein.

### II. Example Computer Implementations

Targeted discounting system 112, merchant registration interface 114, merchant offer interface 116, consumer registration interface 118, consumer offer interface 120, database 122, deal matcher 124, user set determiner 126, deal matcher 324, deal tracker 302, deal analyzer 304, user set determiner 726, user location comparator 702, user transaction analyzer 704, user type designator 706, flowchart 200, flowchart 400, flowchart 500, flowchart 600, flowchart 800, flowchart 900, and/or any further systems, sub-systems, and/or components disclosed herein may be implemented in hardware, or any combination of hardware with software and/or firmware. For example, targeted discounting system 112, merchant registration interface 114, merchant offer interface 116, consumer registration interface 118, consumer offer interface 120, database 122, deal matcher 124, user set determiner 126, deal matcher 324, deal tracker 302, deal analyzer 304, user set determiner 726, user location comparator 702, user transaction analyzer 704, user type designator 706, flowchart 200, flowchart 400, flowchart 500, flowchart 600, flowchart 800, and/or flowchart 900 may be implemented as computer program code configured to be executed in one or more processors. Alternatively, targeted discounting system 112, merchant registration interface 114, merchant offer interface 116, consumer registration interface 118, consumer offer interface 120, database 122, deal matcher 124, user set determiner 126, deal matcher 324, deal tracker 302, deal analyzer 304, user set determiner 726, user location comparator 702, user transaction analyzer 704, user type designator 706, flowchart 200, flowchart 400, flowchart 500, flowchart 600, flowchart 800, and/or flowchart 900 may be implemented as hardware logic/electrical circuitry.

As described above, targeted discounting systems, user devices, and/or merchant devices may generate one or more user interfaces. For instance, targeted discounting systems, user devices, and/or merchant devices may enable user input to be provided from one or more of any type of user interface elements provided by a computing device, including a keyboard, a thumb wheel, a pointing device, a roller ball, a stick pointer, a touch sensitive display, any number of virtual interface elements, a voice recognition system, etc. Graphical user interfaces (GUI) may be displayed in a display of the computing device, such as in a browser window generated by a web browser, an application window, or in other window type mentioned elsewhere herein or otherwise known.

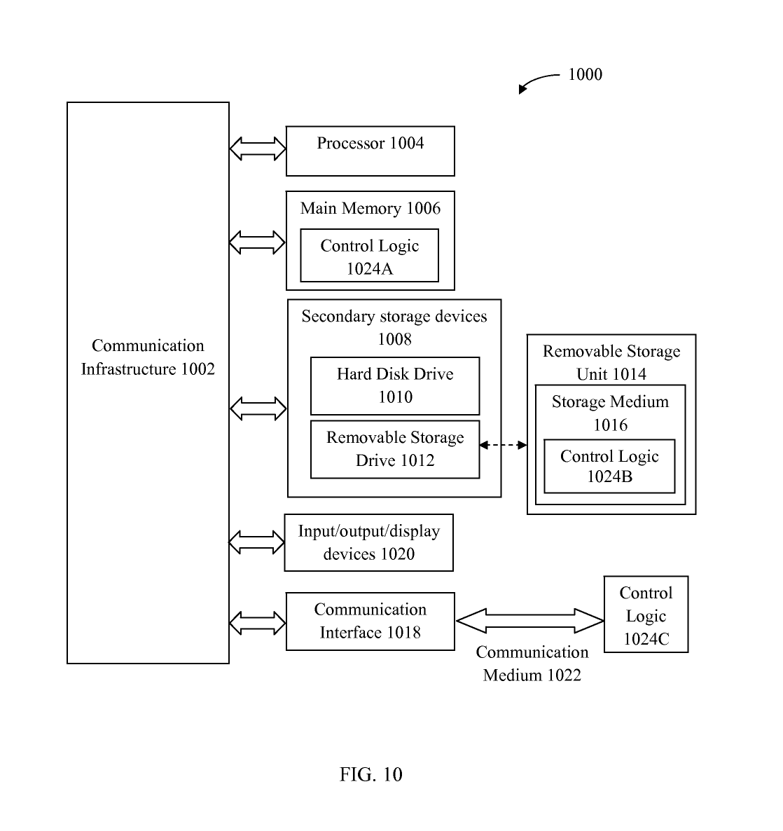

The embodiments described herein, including systems, methods/processes, and/or apparatuses, may be implemented using well known servers/computers, such as a computer 1000 shown in FIG. 10. For example, merchant devices 102 and 104, user devices 106 and 108, targeted discounting system 112, and any of the sub-systems or components contained therein may be implemented using one or more computers 1000.

Computer 1000 can be any commercially available and well known computer capable of performing the functions described herein, such as computers available from International Business Machines, Apple, Sun, HP, Dell, Cray, etc. Computer 1000 may be any type of computer, including a desktop computer, a server, etc.

Computer 1000 includes one or more processors (also called central processing units, or CPUs), such as a processor 1006. Processor 1006 is connected to a communication infrastructure 1002, such as a communication bus. In some embodiments, processor 1006 can simultaneously operate multiple computing threads.

Computer 1000 also includes a primary or main memory 1008, such as random access memory (RAM). Main memory 1008 has stored therein control logic 1024 (computer software), and data.

Computer 1000 also includes one or more secondary storage devices 1010. Secondary storage devices 1010 include, for example, a hard disk drive 1012 and/or a removable storage device or drive 1014, as well as other types of storage devices, such as memory cards and memory sticks. For instance, computer 1000 may include an industry standard interface, such a universal serial bus (USB) interface for interfacing with devices such as a memory stick. Removable storage drive 1014 represents a floppy disk drive, a magnetic tape drive, a compact disk drive, an optical storage device, tape backup, etc.

Removable storage drive 1014 interacts with a removable storage unit 1016. Removable storage unit 1016 includes a computer useable or readable storage medium 1018 having stored therein computer software 1026 (control logic) and/or data. Removable storage unit 1016 represents a floppy disk, magnetic tape, compact disk, DVD, optical storage disk, or any other computer data storage device. Removable storage drive 1014 reads from and/or writes to removable storage unit 1016 in a well-known manner.

Computer 1000 also includes input/output/display devices 1004, such as monitors, keyboards, pointing devices, etc.

Computer 1000 further includes a communication or network interface 1418. Communication interface 1020 enables computer 1000 to communicate with remote devices. For example, communication interface 1020 allows computer 1000 to communicate over communication networks or mediums 1022 (representing a form of a computer useable or readable medium), such as LANs, WANs, the Internet, etc. Network interface 1020 may interface with remote sites or networks via wired or wireless connections.

Control logic 1028 may be transmitted to and from computer 1000 via the communication medium 1022.

Any apparatus or manufacture comprising a computer useable or readable medium having control logic (software) stored therein is referred to herein as a computer program product or program storage device. This includes, but is not limited to, computer 1000, main memory 1008, secondary storage devices 1010, and removable storage unit 1016. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for implementing targeted discounting system 112, merchant registration interface 114, merchant offer interface 116, consumer registration interface 118, consumer offer interface 120, database 122, deal matcher 124, user set determiner 126, deal matcher 324, deal tracker 302, deal analyzer 304, user set determiner 726, user location comparator 702, user transaction analyzer 704, user type designator 706, flowchart 200, flowchart 400, flowchart 500, flowchart 600, flowchart 800, flowchart 900 (including any step of flowcharts 200, 400, 500, 600, 800, and 900), and/or further embodiments described herein. Embodiments of the invention are directed to computer program products comprising such logic (e.g., in the form of program code or software) stored on any computer useable medium. Such program code, when executed in one or more processors, causes a device to operate as described herein.

Note that such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

The invention can work with software, hardware, and/or operating system implementations other than those described herein. Any software, hardware, and operating system implementations suitable for performing the functions described herein can be used.

### III. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method at a deal service, comprising:
receiving a request from a merchant to distribute an at least partially preconfigured promotional offer maintained at the deal service immediately after the request is received, the at least partially preconfigured promotional offer indicating an item offered by the merchant;
selecting a user set to receive the at least partially preconfigured promotional offer;
providing the at least partially preconfigured promotional offer to at least one user of the selected user set; and
confirming the provided offer with one or more users of the selected user set that accepted the provided offer.

2. The method of claim 1, further comprising:
filling in at least one field of the at least partially preconfigured promotional offer with data received in the request.

3. The method of claim 2, further comprising:
filling in at least one field of the at least partially preconfigured promotional offer with data provided by the deal service.

4. The method of claim 1, wherein the at least partially preconfigured promotional offer is fully preconfigured.

5. The method of claim 1, further comprising:
stopping the provided offer according to criteria included in the at least partially preconfigured promotional offer.

6. The method of claim 1, further comprising:
tracking information associated with the provided offer;
analyzing the tracked information and further tracked information associated with further provided offers; and
identifying trends of successful promotional offers.

7. The method of claim 1, wherein the at least partially preconfigured promotional offer recurs on a repeating schedule.

8. The method of claim 1, wherein the at least partially preconfigured promotional offer is increased or decreased at a predetermined rate.

9. A method at a deal service, comprising:
receiving a request from a merchant to distribute an at least partially preconfigured promotional offer maintained at the deal service;
selecting at least one passerby user and at least one repeat user to be included in a user set to receive the at least partially preconfigured promotional offer;
configuring the at least partially preconfigured promotional offer to offer the at least one passerby user a first discount and to offer the at least one repeat user a second discount that is different from the first discount;
providing the at least partially preconfigured promotional offer to at least one user of the selected user set;
confirming the provided offer with one or more users of the selected user set that accepted the provided offer; and
stopping the provided offer according to pre-determined criteria.

10. The method of claim 9, wherein said selecting at least one passerby user and at least one repeat user comprises:
determining whether a current geographical location of a consumer is within a geographical area associated with the merchant;
determining whether the consumer has previously been a customer of the merchant; and
determining whether a stored consumer location is within the geographical area associated with the merchant.

11. The method of claim 10, wherein said selecting at least one passerby user and at least one repeat user further comprises:
indicating that the consumer is a passerby user if the current geographical location of the consumer is within the geographical area associated with the merchant, the consumer has not previously been a customer of the merchant, and the stored consumer location is not within the geographical area associated with the merchant.

12. The method of claim 9, wherein said selecting at least one passerby user and at least one repeat user further comprises:
indicating that the consumer is a repeat user if the consumer has previously been a customer of the merchant

13. The method of claim 9, wherein the first discount is greater than second discount.

14. The method of claim 9, wherein said configuring the at least partially preconfigured promotional offer comprises:
offering the at least one passerby user a first discount during a first time period;
offering the at least one passerby user a second tiered discount during a second time period;
offering the at least one repeat user a third tiered discount during the first time period; and
offering the at least one repeat user a fourth tiered discount during the second time period.

15. The method of claim 9, further comprising:
tracking information associate with the provided offer;
analyzing the tracked information and further tracked information associated with further provided offers;
identifying trends of successful promotional offers; and
identifying characteristics of one or more users of the selected user set that accepted the provided offer.

16. A targeted discounting system comprising:
a database configured to store merchant information, consumer information, and offer information including an at least partially preconfigured promotional offer;
a merchant offer interface configured to receive a request from a merchant to distribute the at least partially preconfigured promotional offer immediately after the request is received, the at least partially preconfigured promotional offer indicating an item offered by the merchant;
a consumer interface configured to provide promotional offers to consumers and receiving acceptance of the promotional offers from the consumers; and
a deal matcher module in communication with the consumer interface, database, and merchant offer interface, the deal matcher module configured to:
access the at least partially preconfigured promotional offer in the database in response to the merchant offer interface having received the request;
select at least one consumer based at least on the consumer information stored in the database,
provide the at least partially preconfigured promotional offer to the at least one selected consumer through the consumer interface, and
confirm the promotional offer with one or more consumers that accepted the provided offer.

17. The targeted discounting system of claim 16, further comprising:
a merchant registration interface configured to enable merchants to register with the targeted discounting system.

18. The targeted discounting system of claim 16, further comprising:
a consumer registration interface configured to enable consumers to register with the targeted discounting system.

19. The targeted discounting system of claim 16, wherein the deal matcher module comprises:
a deal tracker configured to track information associated with the provided offer; and
a deal analyzer configured to analyze the tracked information and further tracked information associated with further provided offers.

20. The targeted discounting system of claim 16, wherein the deal matcher module comprises:
a deal tracker configured to track the acceptance of the provided promotional offer by the selected consumers; and
a deal analyzer configured to analyze the characteristics of consumers using the acceptance of the provided promotional offers.
